(19) United States
(12) Patent Application Publication
(10) Pub. No.: US 2007/0097900 A1
(43) Pub. Date: May 3, 2007

(54) Apparatus and method for controlling transmission/reception power by measuring propagation delay and processing time in a wireless communication system

(75) Inventors: Do-Young Kim, Yongin-si (KR); Sung-Kwon Hong, Gangbuk-gu (KR); Young-Kwon Cho, Suwon-si (KR); Eun-Taek Lim, Suwon-si (KR); Dong-Seek Park, Yongin-si (KR); Marcos Daniel Katz, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/588,433

(22) Filed: Oct. 27, 2006

(30) Foreign Application Priority Data
Oct. 27, 2005 (KR) 2005-0101586

(51) Int. Cl. H04B 7/185

(52) U.S. Cl. 370/318; 455/522

(57) ABSTRACT

An apparatus and method for controlling power in a multi-hop relay broadband wireless communication system are provided. A BS sends a signal to an RS and an MS to estimate distances between the BS, the RS and the MS. Upon receipt of signals from the RS and the MS, the BS measures ToAs of the received signals and detects time information included in the received signals, and calculates propagation delays between the BS, the RS and the MS based on the ToAs and the time information. The BS estimates the distances between the BS, the RS and the MS using the propagation delays, and controls transmission power according to the estimated distances.

### PRIORITY

This application claims priority under 35 U.S.C. §119 to an application filed in the Korean Intellectual Property Office on Oct. 27, 2005 and assigned Serial No. 2005-101586, the contents of which are incorporated herein by reference.

### BACKGROUND OF THE INVENTION

1. Field of the Invention

The present invention relates generally to a multi-hop relay broadband wireless communication system, and in particular, to an apparatus and method for controlling transmission/reception power by measuring propagation delays and processing times among a Base Station (BS), a Relay Station (RS), and a Mobile Station (MS) and estimating distances between them using the propagation delays and processing times in a multi-hop relay broadband wireless communication system.

2. Description of the Related Art

One of the most critical requirements for deployment of a 4^{th} Generation (4G) mobile communication system under recent active research is to build a self-configurable wireless network.

A self-configurable wireless network is a wireless network configured in an autonomous or distributed manner without being under the control of a central system to provide mobile communication services. For the 4G mobile communication system, cells of very small radii are defined for the purpose of enabling high-speed communications and accommodating a larger number of calls. In this case, conventional centralized wireless network design is not feasible. Rather, the wireless network should be built to be under distributed control and to actively cope with an environmental change, such as the addition of a new BS. For this reason, the 4G mobile communication system requires a self-configurable wireless network configuration.

For real deployment of the self-configurable wireless network, techniques used for an ad hoc network should be introduced to the mobile communication system. A major example of these techniques is a multi-hop relay cellular network configured by applying a multi-hop relay scheme used for the ad hoc network to a cellular network with fixed BSs. In general, since a BS and an MS communicate with each other via a direct link in the cellular network, a highly reliable radio link can be established easily between them.

However, due to the fixedness of the BSs, the configuration of the wireless network is not flexible, making it difficult to provide efficient service in a radio environment experiencing a fluctuating traffic distribution and a great change in the number of required calls.

This drawback can be overcome by a relay scheme which delivers data over multiple hops using a plurality of neighbor MSs or neighbor RSs. The multi-hop relay scheme facilitates fast network reconfiguration adaptive to environmental changes and renders the overall wireless network operation efficient. Also, a radio channel in a better channel status can be provided to an MS by installing an RS between the BS and the MS and thus establishing a multi-hop relay path via the RS. In addition, since high-speed data channels can be provided to MSs in a shadowing area or an area where communications with the BS are unavailable, cell coverage is expanded.

FIG. 1 illustrates the configuration of a typical multi-hop relay cellular network.

Referring to FIG. 1, an MS 110 within the BS service area 101 of a BS 100 is connected to the BS 100 via a direct link. On the other hand, an MS 120, which is located outside the BS service area 101 of the BS 100 and thus in a poor channel state, communicates with the BS 100 via a relay link of an RS 130 in RS coverage area 111.

The RS 130 provides better-quality radio channels to the MSs 110 and 120 when they communicate with the BS 100 in a poor channel state as they are located at a boundary of the service area 101. Thus, the BS 100 can provide a high-speed data channel to the cell boundary area using a multi-hop relay scheme and thus expand its cell coverage. As illustrated in FIG. 1, there are a BS-MS link, a BS-RS link, and an RS-MS link in the multi-hop relay cellular network.

As described above, the BS sends a downlink signal to the MS via the relay link established by the RS or via the direct link in the above multi-hop relay broadband wireless communication system. Unless the BS controls transmission power taking into account the distances to the RS and the MS, the signal may interfere with other MSs or RSs.

Conventionally, the BS controls power by sending a signal at a predetermined power level and receiving information about a reception power level from the RS or the MS receiving the signal. This conventional power control requires establishment of a plurality of signal links between the BS and the RS or the MS in the multi-hop relay broadband wireless communication system. As a consequence, resources are wasted and protocol complexity increases.

### SUMMARY OF THE INVENTION

An object of the present invention is to substantially solve at least the above problems and/or disadvantages and to provide at least the advantages below. Accordingly, an object of the present invention is to provide an apparatus and method for measuring propagation delay in a multi-hop relay broadband wireless communication system.

Another object of the present invention is to provide an apparatus and method for controlling transmission/reception power by estimating the distance between a transmitter and a receiver according to a propagation delay measurement between the transmitter and receiver in a multi-hop relay broadband wireless communication system.

The above objects are achieved by providing an apparatus and method for controlling power in a multi-hop relay broadband wireless communication system.

According to one aspect of the present invention, in a power controlling method for a BS in a multi-hop relay broadband wireless communication system, the BS sends a signal to an RS and an MS to estimate distances between the BS, the RS and the MS. Upon receipt of signals from the RS and the MS, the BS measures Time of Arrivals (ToAs) of the received signals and detects time information included in the received signals, and calculates propagation delays among the BS, the RS and the MS based on the ToAs and the time information. The BS estimates the distances among the BS, the RS and the MS using the propagation delays, and controls transmission power according to the estimated distances.

According to another aspect of the present invention, in a power controlling method for an RS in a multi-hop relay broadband wireless communication system, the RS activates a timer, upon receipt of a signal from a BS. Upon receipt of a signal from an MS, the RS detects time information of the timer and time information of the MS included in the received signal, and sends a signal including the time information of the timer and the time information of the MS to the BS. Upon receipt of distances estimated using propagation delays and processing times from the BS, the RS controls the power of a transmission signal according to the estimated distances.

According to a further aspect of the present invention, in a power controlling method for an MS in a multi-hop relay broadband wireless communication system, the MS activates a timer, upon receipt of a signal from a BS. The MS sends a signal including time information of the timer to the BS and the RS. Upon receipt of estimated distances, the MS controls the power of a transmission signal according to the estimated distances.

According to still another aspect of the present invention, in a power controlling apparatus for a BS in a multi-hop relay broadband wireless communication system, upon receipt of signals from an RS and an MS, a time measurer measures ToAs of the received signals and detects time information included in the received signals. A distance estimator estimates the distances between the BS, the RS and the MS using the ToAs and the time information. A power controller controls the power of a transmission signal according to the estimated distances.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates multiple links in a typical multi-hop relay broadband wireless communication system;

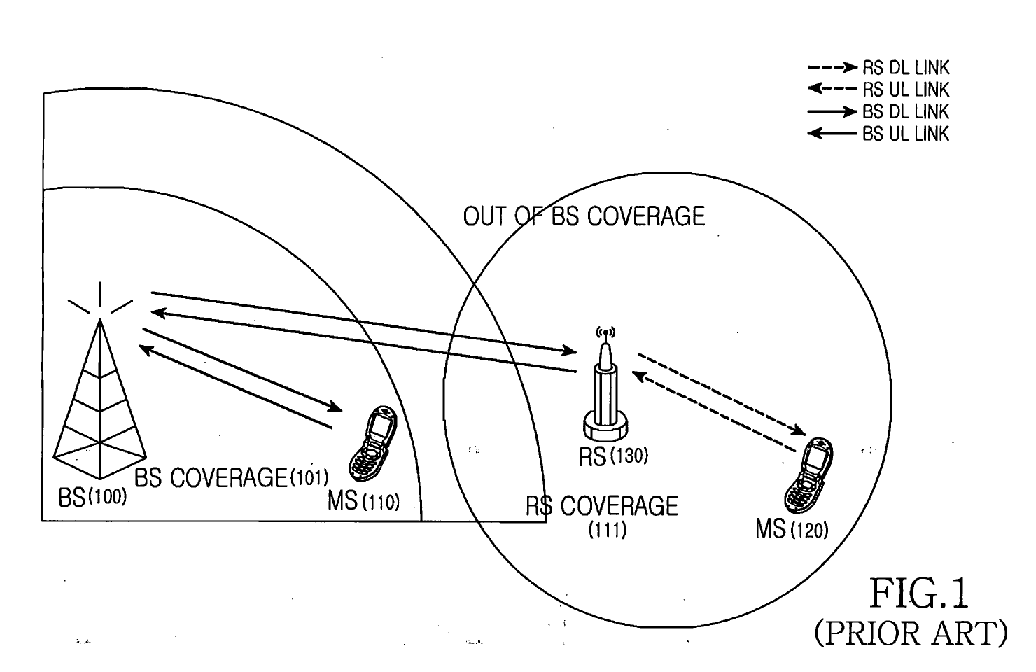

FIG. 2 illustrates a signal flow through signal links for estimating distances in a multi-hop relay broadband wireless communication system according to the present invention;

FIG. 3 is a diagram illustrating signal timings in the multi-hop relay broadband wireless communication system according to the present invention;

FIG. 4 is a block diagram of a BS for power control in the multi-hop relay broadband wireless communication system according to the present invention;

FIG. 5 is a flowchart illustrating a power control operation in the BS in the multi-hop relay broadband wireless communication system according to the present invention;

FIG. 6 is a flowchart illustrating a power control operation in an RS in the multi-hop relay broadband wireless communication system according to the present invention;

FIG. 7 is a flowchart illustrating a power control operation in an MS in the multi-hop relay broadband wireless communication system according to the present invention;

FIG. 8 illustrates a signal flow through signal links in the multi-hop relay broadband wireless communication system according to the present invention; and

FIG. 9 illustrates a signal flow through signal links in the multi-hop relay broadband wireless communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a technique for controlling transmission/reception power by estimating the distance between a transmitter and a receiver in a multi-hop relay broadband wireless communication system. The distance between the transmitter and the receiver is estimated using propagation delays and system signal processing times between a BS, an RS and an MS, by way of example. While the following description is made in the context of an Orthogonal Frequency Division Multiple Access (OFDMA) wireless communication system, it is to be clearly understood that the present invention is also applicable to any other multiple access scheme.

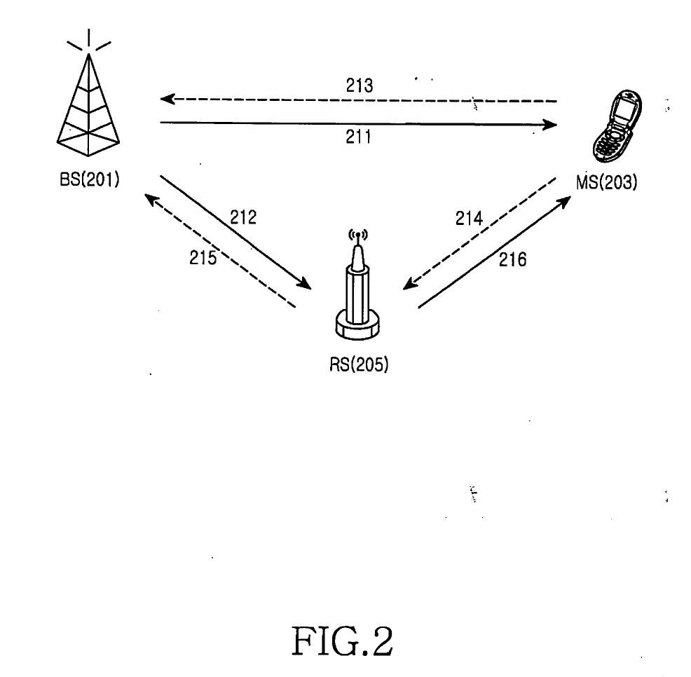

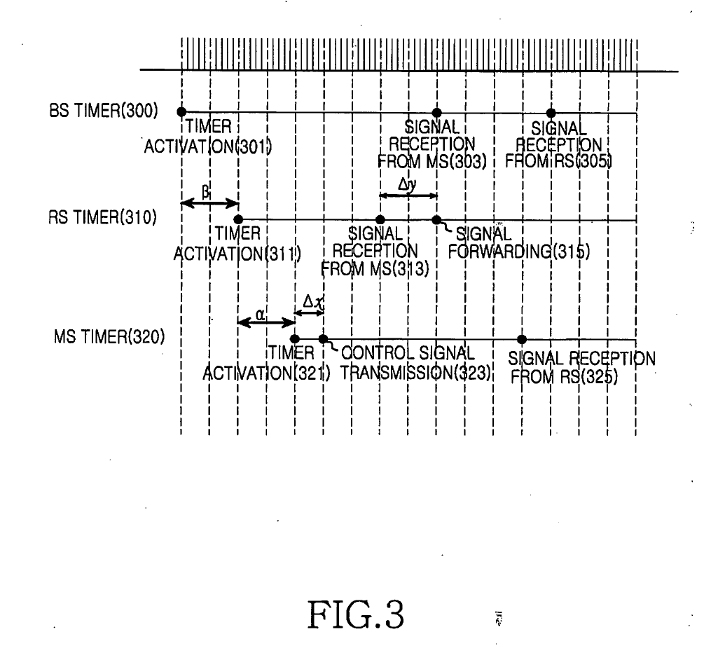

FIG. 2 illustrates a signal flow through signal links for estimating distances in a multi-hop relay broadband wireless communication system according to the present invention, and FIG. 3 illustrates signal timer durations in the BS, the RS and the MS.

Referring to FIG. 2, a BS 201 sends a signal to an MS 203 and an RS 205 to estimate the distances between them based on propagation delays in steps 211 and 212. Simultaneously, the BS 201 activates a BS timer at time 301 in FIG. 3. The transmission signal is a control signal sent for channel estimation or system synchronization before data transmission, or a general data signal.

The MS 203 detects the received signal and activates an MS timer at time 321 in FIG. 3. In steps 213 and 214, the MS 203 sends a control signal to the BS 201 and the RS 205. The control signal includes channel status information between the BS 201 and the MS 203 and a processing time Δₓ in the MS 203. The processing time Δₓ spans from time 321 to time 323 in FIG. 3, counted by the MS timer.

Upon receipt of the control signal from the MS 203 in step 213, the BS 201 counts the Round Trip Delay (RTD) between the BS 201 and the MS 203 by the BS timer. The RTD spans from time 301 to time 303 in FIG. 3. Because the RTD includes the processing time Δₓ of the MS 203, the propagation delay between the BS 201 and the MS 203 is calculated by Equation (1):

$${T}_{S \to D} \approx \frac{( {T}_{S ↔ D} - {Δ}_{x} )}{2} \qquad ( 1 )$$

where T_{S→D} denotes the propagation delay from the BS 201 to the MS 203, T_{S→D} denotes the RTD between them, measured by the BS 201, and Δₓ denotes the processing time of the MS 203. Assuming that the downlink and the uplink between the BS 201 and the MS 203 are identical, the downlink and the uplink experience an equal propagation delay.

Upon receipt of the signal from the BS 201 in step 212, the RS 205 activates an RS timer at time 311 in FIG. 3. When the RS 205 receives the control signal from the MS 203 in step 214, it counts the time span from the reception of the signal from the BS 201 (time 311) and the reception of the control signal from the MS 203 (time 313) by the RS timer. The time span is expressed as Equation (2):
T_{R}≈(T_{D→R}+α)+Δₓ (2)
where T_{R} denotes the time from the reception of the signal from the BS 201 to the reception of the control signal from the MS 203, T_{D→R} denotes the propagation delay from the MS 203 to the RS 205, a denotes the time between the reception of the signal from the BS 201 in the RS 205 and the reception of the signal from the BS 201 in the MS 203, and Δₓ denotes the processing time of the MS 203.

Then, the RS 205 forwards the signal received from the BS 201 to the MS 203 in step 216 and forwards the signal received from the MS 203 to the BS 201 in step 215. These signals contain T_{R} and the processing time Δ_{y} of the RS 205, i.e. from time 311 to time 315 in FIG. 3. T_{R} and Δ_{y} are carried in the form of integers in a frame-like structure, for example, in a preamble or reserved bits of a frame.

Upon receipt of the signal from the RS 205, the BS 201 calculates the RTD (time 301 to time 305 in FIG. 3) between the BS 201 and the RS 205 using the BS timer by Equation (3):
T_{S}≈T_{R}+Δ_{y}+T_{R→S}−(T_{D→R}+α)+Δₓ+Δ_{y}+T_{R⇄S} (3)
where T_{S} denotes the time between the signal transmission to the RS 205 and the signal reception from the RS 205, T_{R} denotes the time from the signal reception from the BS 201 and the signal reception from the MS 203, T_{R⇄S} denotes the RTD between the BS 201 and the RS 205, T_{D→R} denotes the propagation delay from the MS 203 to the RS 205 denotes the time between the reception of the signal from the BS 201 in the RS 205 and the reception of the signal from the BS 201 in the MS 203, Δ_{y} denotes the processing time of the RS 205, and Δₓ denotes the processing time of the MS 203.

Using T_{R} and Δ_{y} included in the signal received from the RS 205, the BS 201 calculates the propagation delay between the BS 201 and the RS 205 by Equation (4):

$${T}_{R \to S} \approx \frac{( {T}_{S} - ( {T}_{R} + {Δ}_{y} ) )}{2} \qquad ( 4 )$$

where T_{R→S} denotes the propagation delay from the RS 205 to the BS 201, T_{S} denotes the time between the signal transmission from the BS 201 to the RS 205 and the signal reception from the RS 205 in the BS 201, T_{R} denotes the time from the signal reception from the BS 201 in the RS 205 and the signal reception from the MS 203 in the RS 205, and Δ_{y} denotes the processing time of the RS 205.

The propagation delay T_{S→D} from the MS 203 to the BS 201 is given as Equation (5):
T_{S→D}=α+T_{S→R}=α+T_{R→S} (5)
where α denotes the time between the reception of the signal from the BS 201 in the RS 205 and the reception of the signal from the BS 201 in the MS 203, T_{S→R} denotes the propagation delay from the BS 201 to the RS 205, and T_{R→S} denotes the propagation delay from the RS 205 to the BS 201.

Since a is obtained by Equation (2) or Equation (3), the propagation delay between the MS 203 and the RS 205 is determined by Equation (6):
T_{D→R}=T_{R}−(α+Δₓ) (6)
where T_{R} denotes the time from the signal reception from the BS 201 in the RS 205 and the signal reception from the MS 203 in the RS 205, a denotes the time between the reception of the signal from the BS 201 in the RS 205 and the reception of the signal from the BS 201 in the MS 203, and Δₓ denotes the processing time of the MS 203.

Using the propagation delays of signals among the BS 201, the MS 203, and the RS 205 via the links as illustrated in FIG. 2, the distances between them are calculated by Equation (7):
R_{S→D}=C×T_{S→D}
R_{D→R}=C×T_{D→R}
R_{R→S}=C×T_{R=S} (7)
where C denotes a propagation velocity, 3×10⁸ m/sec, T_{S→D} denotes the propagation delay from the BS 201 to the MS 203, T_{D→R} denotes the propagation delay from the MS 203 to the RS 205, and T_{R→S} denotes the propagation delay from the RS 205 to the BS 201.

The BS can control its transmission power according to the distances between the BS, the MS and the RS calculated by Equation (7). Thus, interference between the RS or the MS communicating with the BS and other systems is minimized. Also, since the BS sends distance information to the RS and the MS, the RS and the MS control their transmit power, thereby efficiently saving power.

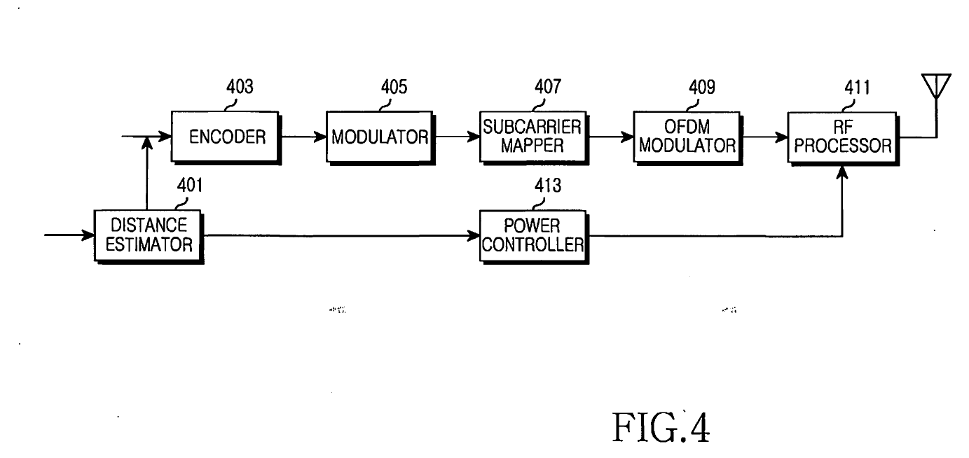

FIG. 4 is a block diagram of the BS for power control in the multi-hop relay broadband wireless communication system according to the present invention.

Referring to FIG. 4, the BS includes a distance estimator 401, an encoder 403, a modulator 405, a subcarrier mapper 407, an Orthogonal Frequency Division Multiplexing (OFDM) modulator 409, a Radio Frequency (RF) processor 411, and a power controller 413.

The distance estimator 401 calculates propagation delays and processing times using time information received from the RS and the MS by Equation (1) to Equation (7), and estimates the distances among the BS, the MS and the RS using on the propagation delays and the processing times. The distance estimator 401 provides the distance information to the encoder 403, for transmission of the distance information to the MS and the RS, and to the power controller 413, for controlling transmission power to the MS and the RS.

The encoder channel-encodes input information data at a predetermined coding rate to achieve robustness against a radio channel. The information data includes the distance information. The modulator 405 modulates the coded data in a predetermined modulation scheme such as Binary Phase Shift Keying (BPSK), Quadrature Phase Shift Keying (QPSK), 16-ary Quadrature Amplitude Modulation (16 QAM), or 64 QAM. The subcarrier mapper 407 maps the modulated data to subcarriers.

The OFDM modulator 409 converts the mapped data to time sample data by Inverse Fast Fourier Transform (IFFT).

The RF processor 411 upconverts the baseband signal received from the OFDM modulator 409 to an RF signal and sends the RF signal to the RS or the MS through an antenna, controlling the power of the RF signal under the control of the power controller 413.

The power controller 413 outputs a power control signal for controlling the transmission power of the signal to be sent through the RF processor 411 based on the estimated distances between the BS, the RS and the MS received from the distance estimator 401.

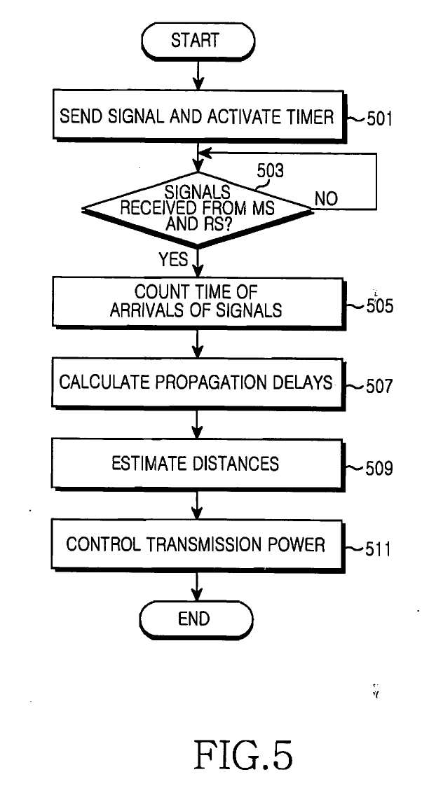

FIG. 5 is a flowchart illustrating a power control operation in the BS in the multi-hop relay broadband wireless communication system according to the present invention.

Referring to FIG. 5, the BS sends a signal to the RS and the MS to calculate propagation delays to the RS and the MS in step 501. Simultaneously, the BS activates its timer. The transmitted signal includes one of a control signal, a control frame such as a preamble, and a data frame.

In step 503, the BS monitors reception of signals from the MS and the RS. Upon receipt of the signals from the MS and the RS, the BS checks the Time of Arrivals (ToAs) of the signals from the MS and the RS using the timer in step 505.

The BS then checks time information included in the received signals and calculates propagation delays in step 507. The time information contains information about time measurements counted by the MS timer and the RS timer.

The BS calculates the propagation delays between the BS, the MS and the RS using the ToAs and the time information by Equation (1) to Equation (6). Time information obtained by the BS timer includes the ToAs of the signals from the MS and the RS. The time information obtained by the MS timer includes the processing time of the MS, and the time information obtained by the RS timer includes the processing time of the RS includes the processing time of the RS and a time span between reception of the signal from the BS and reception of a signal from the MS.

In step 509, the BS estimates the distance between the BS, the MS and the RS using the propagation delays by Equation (7).

The BS then controls the transmission power of a signal to be sent according to the estimated distances in step 511. For example, the power is controlled referring to a quantitatively made-up power scheduling table like Table 1 below.

Table 1 is an example of a power scheduling table by which to perform a quantitative power control proportional to distance.

TABLE 1

| | Power Level | R_{S→D} | R_{D→R} | R_{R→S} | R_{S→D}: R_{D→R}: R_{R→S} |
|---|---|---|---|---|---|
| Within cell | Class A | Default | Default | Default | |
| radius | Class B | Class A + X | Class A + Y | Class A + Z | |
| | Class C | Class B + X | Class B + Y | Class B + Z | |
| | Class D | Class C + X | Class C + Y | Class C + Z | |
| | . | . | . | . | |
| | . | . | . | . | |
| | . | . | . | . | |
| | Class N | Class N | Class N | Class N | |
| Outside cell | | Starts from | Starts from | Starts from | |
| radius | | Default for | Default for | Default for | |
| | | Class N or | Class N or | Class N or | |
| | | higher class | higher class | higher class | |

Referring to Table 1, transmission power is controlled to a predetermined power level according to the distance information. The distance-based power levels listed in Table 1 may be continuously changed by a channel estimation algorithm when communication paths are established.

Then the BS ends the process.

As described above, the transmission power of signals to be sent to the RS and the MS is controlled by estimating the distances between the BS, the RS, and the MS. The BS notifies the RS and the MS of the estimated distances so that the RS and the MS can control transmission power between them.

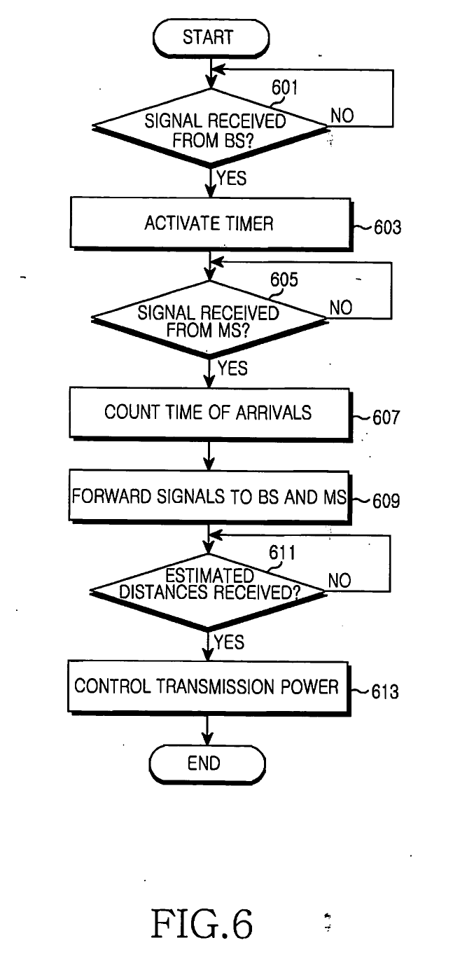

FIG. 6 is a flowchart illustrating a power control operation in the RS in the multi-hop relay broadband wireless communication system according to the present invention.

Referring to FIG. 6, the RS monitors reception of a signal from the BS in step 601 and upon receipt of the signal, it activates the RS timer in step 603.

In step 605, the RS monitors reception of a signal from the MS. Upon receipt of the signal from the MS, the RS measures the ToA of the received signal using the RS timer in step 607. The ToA covers the processing time Δₓ of the MS, the propagation delay T_{D→R} from the MS to the RS, and the difference a between the propagation delay from the BS to the MS and the propagation delay from the BS to the RS.

In step 609, the RS forwards the signal received from the BS to the MS and forwards the signal received from the MS to the BS.

The RS monitors reception of estimated distances between the BS, the MS and the RS from the BS in step 611. Upon receipt of the estimated distances, the RS sends a signal to the BS or the MS at a power level controlled according to the estimated distances in step 613. The RS then ends the process of the present invention.

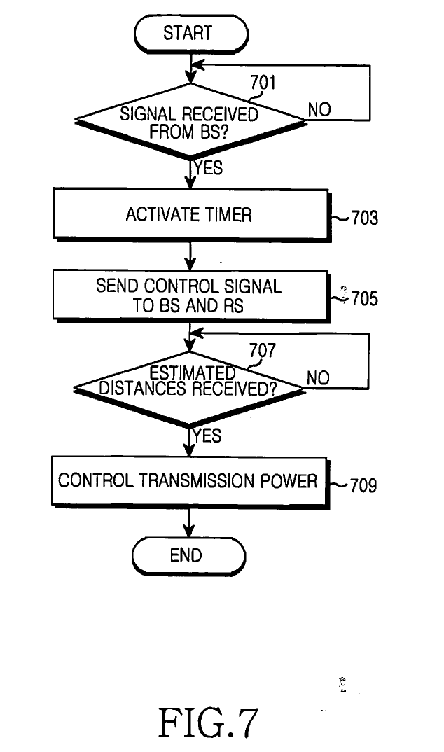

FIG. 7 is a flowchart illustrating a power control operation in the MS in the multi-hop relay broadband wireless communication system according to the present invention.

Referring to FIG. 7, the MS monitors reception of a signal from the BS in step 701. Upon receipt of the signal from the BS, the MS activates the MS timer in step 703.

In step 705, the MS sends a control signal including the processing time of the MS to the BS and the RS.

The MS then monitors reception of estimated distances between the BS, the MS and the RS from the BS in step 707.

Upon receipt of the estimated distances, the MS sends a signal to the RS and the BS at a power level controlled according to the estimated distances in step 709. Then the MS ends the process.

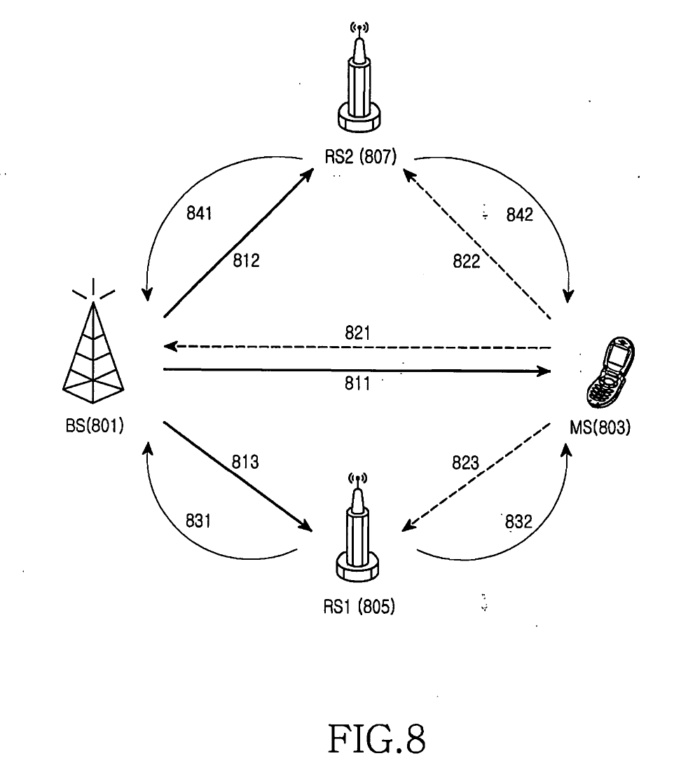

FIG. 8 illustrates a signal flow through signal links in the multi-hop relay broadband wireless communication system according to the present invention.

Referring to FIG. 8, when two RSs 805 and 807 exist, the distances between a BS 801, an MS 803, and the RSs 805 and 807 are estimated using the propagation delays between them, as illustrated in FIG. 2.

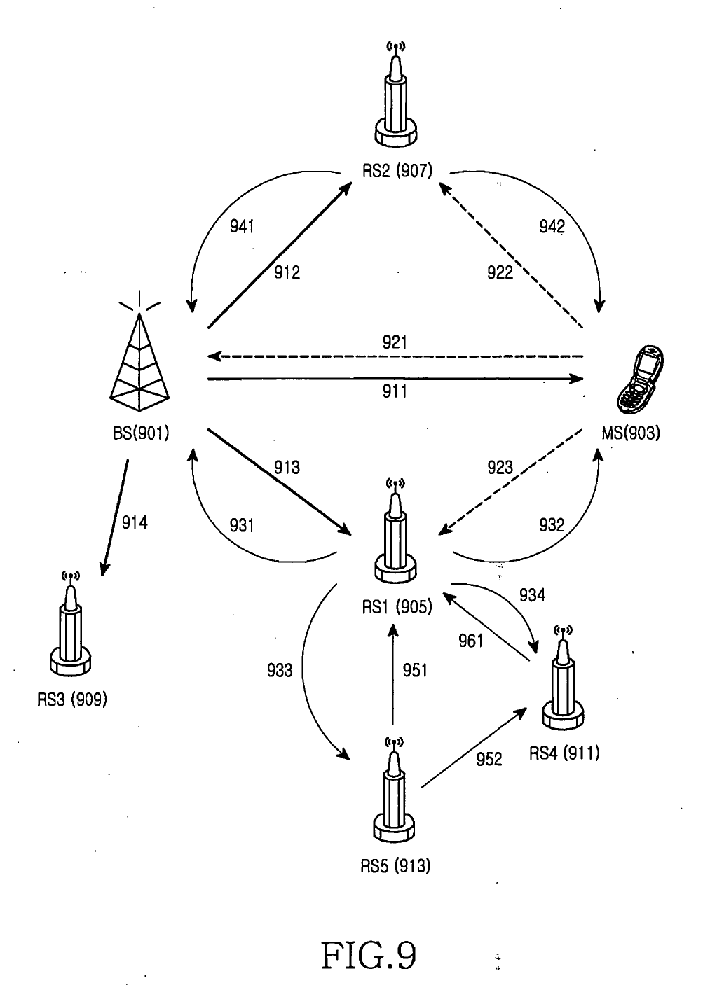

FIG. 9 illustrates a signal flow through signal links in the multi-hop relay broadband wireless communication system according to the present invention. The distances between the BS, the MS and the RS are estimated in the same manner as in FIG. 8.

Referring to FIG. 9, the distances between RSs 905, 911 and 913 are estimated. When it receives a signal from a BS 901, the RS 905 (RS 1) activates its timer and estimates the distances between the RSs 905, 911 and 913 in the same manner as in FIG. 2.

For power control, the distances between the BS, the MS and the RS may be estimated in an early stage of communications or periodically estimated taking into account of the mobility of the RS or the MS.

In the above embodiments, the propagation delays are calculated by signaling among the BS, the MS and the RS and the distances are estimated using the propagation delays. Also, the distances can be calculated using Global Positioning System (GPS) without time synchronization.

In accordance with the present invention as described above, the distances between the BS, the MS and the RS are estimated using the propagation delays and power control is carried out according to the distances in the multi-hop relay broadband wireless communication system. Therefore, interference is reduced between systems and the power consumption of the RS or the MS is efficiently decreased.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A power controlling method in a Base Station (BS) in a multi-hop relay broadband wireless communication system, comprising the steps of:
sending a signal to a Relay Station (RS) and a Mobile Station (MS) to estimate distances between the BS, the RS and the MS;
measuring, upon receipt of signals from the RS and the MS, Time of Arrivals (ToAs) of the received signals and detecting time information included in the received signals;
calculating propagation delays between the BS, the RS and the MS based on the ToAs and the time information;
estimating the distances between the BS, the RS and the MS using the propagation delays; and
controlling transmission power according to the estimated distances.

2. The power controlling method of claim 1, wherein the signal sent to the RS and the MS is one of a control signal and a data signal.

3. The power controlling method of claim 1, wherein the time information included in the signal received from the RS contains processing time of the RS, a propagation delay between the MS and the RS, and the difference between ToAs of the signal sent from the BS in the RS and the MS.

4. The power controlling method of claim 1, wherein the time information included in the signal received from the MS contains processing time of the MS.

5. The power controlling method of claim 1, wherein the time information included in the signals received from the RS and the MS is set using timers activated by the RS and the MS when the RS and the MS receive the signal from the BS.

6. The power controlling method of claim 1, wherein the transmission power controlling step comprises:
determining a power level for a transmission signal in correspondence with the estimated distances, referring to a power scheduling table; and
controlling the transmission power to the determined power level.

7. The power controlling method of claim 6, wherein the power scheduling table is updated through channel estimation every predetermined period.

8. The power controlling method of claim 1, further comprising notifying the RS and the MS of the estimated distances.

9. The power controlling method of claim 1, further comprising calculating the distances among the BS, the RS and the MS using Global Positioning System (GPS).

10. A power controlling method in a Relay Station (RS) in a multi-hop relay broadband wireless communication system, comprising the steps of:
activating a timer, upon receipt of a signal from a Base Station (BS);
checking, upon receipt of a signal from a Mobile Station (MS), time information of the timer and time information of the MS included in the received signal;
sending a signal including the time information of the timer and the time information of the MS to the BS; and
controlling, upon receipt of distances estimated using propagation delays and processing times from the BS, the power of a transmission signal according to the estimated distances.

11. The power controlling method of claim 10, wherein the time information of the MS contains processing time of the MS.

12. The power controlling method of claim 10, wherein the time information of the timer includes a time span from signal reception from the BS to signal reception from the MS, and processing time of the RS.

13. The power controlling method of claim 10, further comprising forwarding the signal received from the BS to the MS.

14. The power controlling method of claim 10, wherein the power controlling step comprises:
determining a power level for the transmission signal in correspondence with the estimated distances, referring to a power scheduling table; and
controlling the power of the transmission signal to the determined power level.

15. The power controlling method of claim 14, wherein the power scheduling table is updated through channel estimation every predetermined period.

16. A power controlling method in a Mobile Station (MS) in a multi-hop relay broadband wireless communication system, comprising:
activating a timer, upon receipt of a signal from a Base Station (BS);
sending a signal including time information of the timer to the BS and the RS; and
controlling, upon receipt of estimated distances, the power of a transmission signal according to the estimated distances.

17. The power controlling method of claim 16, wherein the time information of the timer contains processing time of the MS.

18. The power controlling method of claim 16, wherein the power controlling step comprises:
determining a power level for the transmission signal in correspondence with the estimated distances, referring to a power scheduling table; and
controlling the power of the transmission signal to the determined power level.

19. The power controlling method of claim 18, wherein the power scheduling table is updated through channel estimation every predetermined period.

20. A power controlling method in a multi-hop relay broadband wireless communication system, comprising the steps of:
sending a signal from a Base Station (BS) to a Relay Station (RS) and a Mobile Station (MS) to estimate distances between the BS, the RS and the MS, and activating a BS timer in the BS;
activating an MS timer in the MS, upon receipt of the signal from the BS, and sending a signal including time information of the MS timer from the MS to the BS and the RS;
activating an RS timer, upon receipt of the signal from the BS, and checking, upon receipt of the signal from the MS, time information of the RS timer and the time information of the MS timer included in the signal from the MS in the RS;
sending a signal including the time information of the MS timer and the time information of the RS timer from the RS to the BS;
calculating propagation delays between the BS, the RS and the MS based on the time information of the RS timer and the time information of the MS timer included in the signal received from the RS in the BS;
estimating the distances between the BS, the RS and the MS using the propagation delays in the BS; and
controlling transmission power according to the estimated distances in the BS.

21. The power controlling method of claim 20, wherein the time information of the MS timer contains processing time of the MS.

22. The power controlling method of claim 20, wherein the time information of the RS timer includes processing time of the RS and a time span from the signal reception from the BS to the signal reception from the MS.

23. The power controlling method of claim 20, further comprising sending the estimated distances from the BS to the RS and the MS.

24. The power controlling method of claim 20, wherein the transmission power controlling step comprises:
determining a power level for a transmission signal in correspondence with the estimated distances, referring to a power scheduling table; and
controlling the transmission power to the determined power level.

25. The power controlling method of claim 24, wherein the power scheduling table is updated through channel estimation every predetermined period.

26. A power controlling apparatus in a Base Station (BS) in a multi-hop relay broadband wireless communication system, comprising:
a time measurer for, upon receipt of signals from a Relay Station (RS) and a Mobile Station (MS), measuring Time of Arrivals (ToAs) of the received signals and detecting time information included in the received signals;
a distance estimator for estimating the distances between the BS, the RS and the MS using the ToAs and the time information; and
a power controller for controlling the power of a transmission signal according to the estimated distances.

27. The power controlling apparatus of claim 26, wherein the time measurer comprises a timer for being activated when a signal is sent to the RS and the MS, and counting time until receiving the signals from the RS and the MS.

28. The power controlling apparatus of claim 26, wherein the distance estimator calculates propagation delays between the BS, the MS and the RS based on the ToAs and the detected time information, and estimates the distances using the propagation delays.

29. The power controlling apparatus of claim 26, wherein the power controller includes a table listing power levels with respect to distances, determines a power level for the transmission signal in correspondence with the estimated distances, referring to the table, and controls the power of the transmission signal to the determined power level.

30. The power controlling apparatus of claim 29, wherein the power scheduling table is updated through channel estimation every predetermined period.
